(19) United States
(12) Patent Application Publication
(10) Pub. No.: US 2002/0165933 A1
(43) Pub. Date: Nov. 7, 2002

(54) System to acquire location information

(76) Inventors: Philip Shi-lung Yu, Chappaqua, NY (US); Edith H. Stern, Yorktown Heights, NY (US); Barry E. Willner, Briarcliff Manor, NY (US); David P. Greene, Ossining, NY (US)

Correspondence Address: BUCKLEY, MASCHOFF, TALWALKAR, & ALLISON, 5 ELM STREET, NEW CANAAN, CT, 06840, US

(21) Appl. No.: 09/840,777

(22) Filed: Apr. 24, 2001

(51) Int. Cl. G06F 15/16

(52) U.S. Cl. 709/217; 709/224

(57) ABSTRACT

A system to acquire information associated with a location includes search of a network for sensor measurements associated with a location, and acquisition from the network of a plurality of sensor measurements associated with the location. According to the invention, the acquired plurality of sensor measurements includes measurements obtained by a plurality of entities. By virtue of this arrangement, a user is able to efficiently receive a representation of the location based on available sensor measurements.

### BACKGROUND OF THE INVENTION

1. Field of the Invention

The present invention relates to systems for obtaining information from sensors. More specifically, the present invention concerns a system to obtain sensor measurements associated with a location.

2. Description of the Related Art

Sensors are increasingly prevalent in modern life. In conjunction with modern computing equipment, sensors have proven to be tremendously useful in monitoring, informing, and gathering information. The term sensors is used herein to describe any device for obtaining data concerning a physical phenomena, such as a video camera, a still camera, a temperature sensor, a wind gauge, an elevation gauge, a Geiger counter, a GPS device, or the like.

Many entities operating sensors have recently made sensor measurements obtained by their sensors available to the public. Most commonly, members of the public are able to access such sensor measurements over the World Wide Web (“the Web”) through an associated Internet Protocol (“IP”) address. More specifically, a user inputs a Web address into a Web browser, the Web address is resolved into an IP address, a request is transmitted to the IP address, and a sensor measurement is returned to the Web browser. The browser presents the sensor measurement to the user in an appropriate manner. For example, the browser displays video data in a case that the sensor measurement comprises video data, and plays a sound over speakers in a case that the sensor measurement comprises audio data.

Using the foregoing system, a user is required to know or search for a particular network address associated with a sensor in order to obtain a measurement associated with the sensor. Even if the user were able to locate a suitable network address, the network address would only enable the user to receive sensor measurements obtained by sensors operated by the single entity providing the network address. Accordingly, it is currently quite difficult for users to efficiently exploit the existing network of publicly-available sensor measurements.

In view of the foregoing, what is needed is a system to leverage publicly-available sensors and sensor measurements in order to provide a user with information concerning a given location in a more efficient manner than currently available.

### SUMMARY OF THE INVENTION

To address these needs, the present invention relates to a system to acquire information associated with a location in which a network is searched for sensor measurements associated with a location, and a plurality of sensor measurements associated with the location is acquired from the network. According to the invention, the acquired plurality of sensor measurements includes measurements obtained by a plurality of entities. By virtue of this arrangement, a user is able to acquire disparate sensor measurements associated with a given location and to thereby efficiently receive a representation of the location based on available sensor measurements.

In further aspects of the invention, a request to obtain information associated with the location is received, and the plurality of sensor measurements are acquired by identifying a stored sensor measurement associated with the location and determining if the stored sensor measurement satisfies a timeframe requirement. If the stored sensor measurement does not satisfy the timeframe requirement, a sensor measurement satisfying the timeframe requirement is acquired. These further aspects provide additional efficiency in acquiring sensor measurements by using stored sensor measurements in cases except those in which the stored measurements do not satisfy a timeframe requirement that is based on the received request.

With these and other advantages and features that will become hereafter apparent, a more complete understanding of the nature of the invention can be obtained by referring to the following detailed description and to the drawings appended hereto.

### BRIEF DESCRIPTION OF THE DRAWINGS

FIG. 1 is a flow diagram of process steps to acquire sensor measurements according to embodiments of the present invention.

FIG. 2 is a topographic view of a network architecture according to embodiments of the present invention.

FIG. 3 is a block diagram of an internal architecture of a server according to embodiments to the present invention.

FIG. 4 is a block diagram of an internal architecture of a user device according to embodiments to the present invention.

FIG. 5 is a representative view of a tabular portion of a sensor measurement database according to embodiments of the present invention.

FIG. 6 is a flow diagram of process steps to obtain sensor measurements according to embodiments of the present invention.

FIG. 7 is an outward view of a display presenting sensor measurements according to embodiments of the present invention.

### DETAILED DESCRIPTION

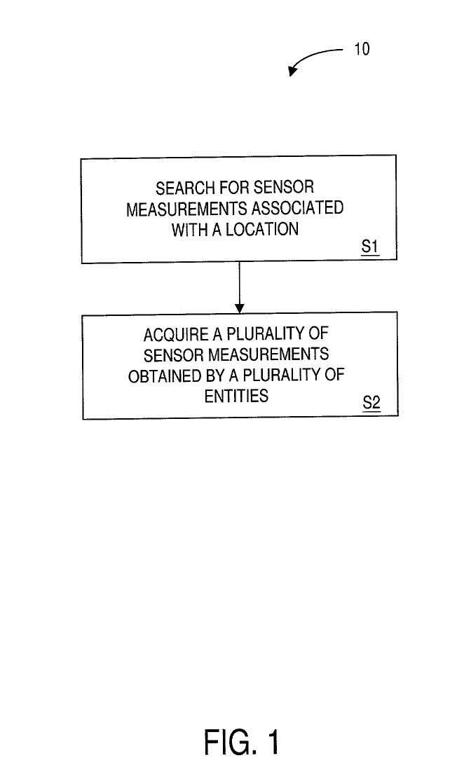

FIG. 1 is a flow diagram of process steps 10 to acquire sensor measurements according to embodiments of the present invention. In order to provide an immediate introduction to features of the present invention, process steps 10 will now be described without reference to a particular embodiment. Of course, a complete description of specific hardware and software embodiments of the claimed invention is set forth below.

Initially, in step S1, a search is conducted for sensor measurements associated with a location. The search may be conducted by a server that has received a request to obtain information associated with the location. In a more specific example, a user operates a Web browser to input a request to obtain information associated with a location. The Web browser transmits the request to a Web server, and the Web server conducts a search for sensor measurements associated with the location in step S1.

A plurality of sensor measurements is acquired in step S2. The plurality of sensor measurements comprises measurements obtained by two or more entities. For example, one of the acquired sensor measurements may be wind data measured by a wind gauge operated by the National Weather Service while another one of the measurements may be video data measured by a video camera operated by a retailer situated at the location.

According to some embodiments, one or more of the plurality of sensor measurements are acquired from a database comprising sensor measurements and associated locations. In order to populate such a database, the network may be periodically searched for sensor measurements associated with each location and a plurality of sensor measurements may be acquired therefrom. That is, process steps 10 need not necessarily be performed in response to a request from a user. It should also be noted that, additionally or alternatively, one or more sensor measurements may be acquired not from a stored database but directly from sensors associated with the location.

Network Architecture

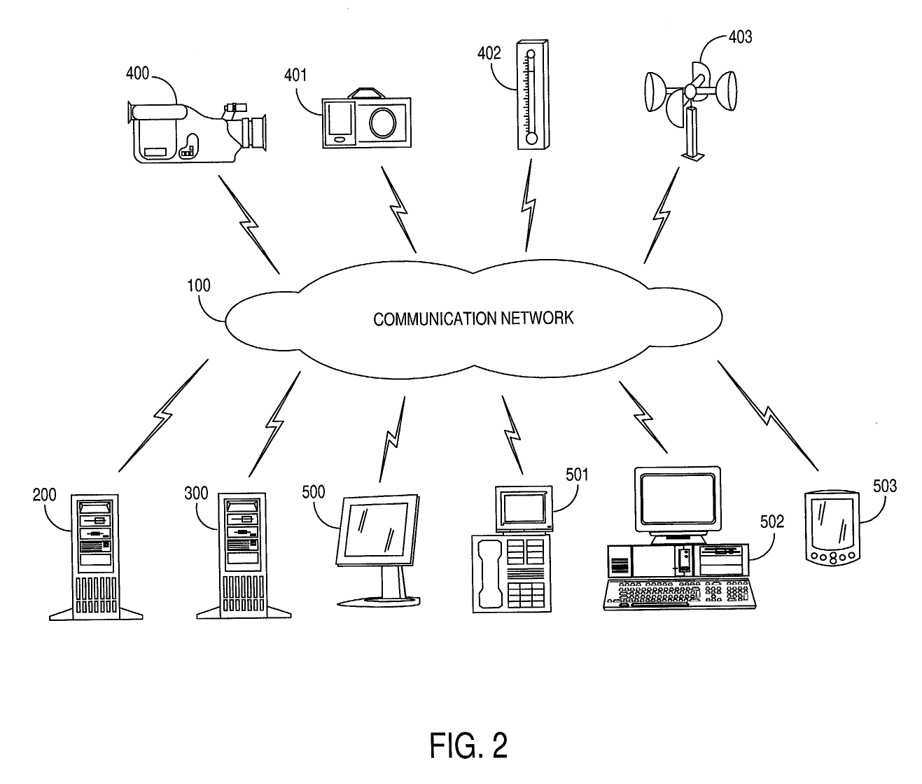

FIG. 2 is a topographic view of a network architecture according to embodiments of the present invention. Of course, network architectures other that that shown in FIG. 2 may be used to implement the invention.

FIG. 2 shows communication network 100 in communication with server 200, sensor server 300, sensors 400 to 403, and user devices 500 to 503. Communication network 100 may comprise any number of systems for transferring data, including a local area network, a wide area network, a telephone network, a cellular network, a fiber-optic network, a satellite network, an infra-red network, a radio frequency network, and any other type of network, which may be used to transmit information between devices. Additionally, communication network 100 may be used to transmit data using any known transmission protocol, such as Asynchronous Transfer Mode (ATM), Internet Protocol (IP), Hypertext Transfer Protocol (HTTP) and Wireless Application Protocol (WAP). In one embodiment, communication network 100 is the World Wide Web.

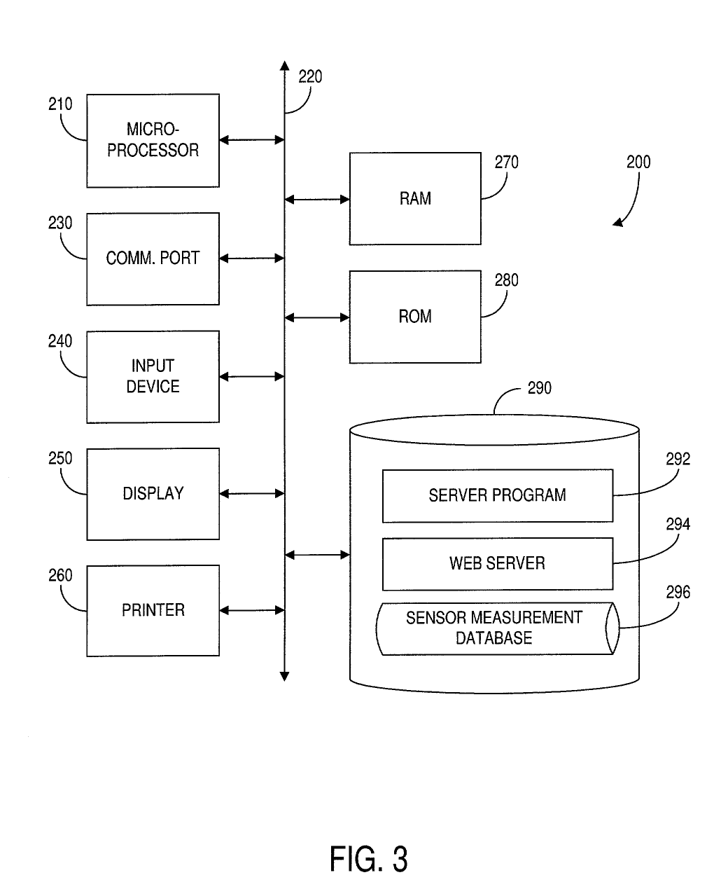

Server 200 may comprise a network server or other device capable of performing the functions attributed to server 200 herein. In addition to these functions, server 200 may control various operations of an entity providing sensor measurements according to the invention, such as user registration, billing, transaction monitoring, communication with other entities obtaining sensor measurements, and the like. According to one embodiment, server 200 operates to search a network for sensor measurements associated with a location and to acquire from the network a plurality of sensor measurements associated with the location, wherein the identified plurality of sensor measurements are measurements obtained by a plurality of entities. Details of one embodiment of server 200 are set forth below with respect to FIG. 3.

Server 300 stores sensor measurements and is operated by an entity different from the entity operating server 200. Accordingly, server 200 may search server 300 for sensor measurements and may acquire sensor measurements from server 300. Server 300 obtains the stored sensor measurements from sensors connected directly to server 300 or connected over a network. Like server 200, server 300 may populate a stored database of sensor measurements by searching a network for sensor measurements associated with a location and acquiring from the network a plurality of sensor measurements associated with the location.

Sensors 400 to 403 comprise a video camera, a still camera, a thermometer, and a wind gauge, respectively. Each of sensors 400 to 403 obtains sensor measurements on behalf of an entity. Specifically, sensor 400 obtains video data, sensor 401 obtains image data, sensor 402 obtains temperature data, and sensor 403 obtains wind data. Of course, the present invention may be embodied using many other types of sensors, including fixed and mobile sensors, and corresponding sensor measurements.

User devices 500 to 503 comprise, respectively, a kiosk terminal, a video telephone, a workstation and a Personal Digital Assistant (PDA). User devices 500 to 503 may be operated by a user to receive and to present sensor measurements to the user. Specifically, a user inputs a location into one of user devices 500 to 503 and, in response, a plurality of sensor measurements are received and presented to the user. In this regard, the sensor measurements may be presented by any means, including visually and aurally. Of course, any device or devices capable of receiving and presenting sensor measurements may be employed as a user device according to some embodiments of the invention.

According to other embodiments, the elements of FIG. 2 are connected differently than as shown. For example, some or all of the elements may be connected directly to one another. Of course, embodiments of the invention may include elements that are different from those shown.

It should be noted that the devices shown in communication with each other might not be constantly exchanging data. Rather, communication may be established when necessary and severed at other times or always available but rarely used to transmit data. Moreover, although the illustrated communication links between the components of FIG. 2 appear dedicated, it should be noted that each of the links may be shared by other components.

Server

FIG. 3 is a block diagram of the internal architecture of server 200 according to one embodiment of the invention. As illustrated, server 200 includes microprocessor 210 in communication with communication bus 220. Microprocessor 210 may be a Pentium™, RlSC™-based, or other type of processor and is used to execute processor-executable process steps so as to control the components of server 200 to provide functionality according to embodiments of the present invention.

Also in communication with communication bus 220 is communication port 230. Communication port 230 is used to transmit data to and to receive data from devices external to server 200. Communication port 230 is therefore preferably configured with hardware suitable to physically interface with desired external devices and/or network connections. In some embodiments, requests for sensor measurements and sensor measurements are received and representational views based on sensor measurements are transmitted over communication port 230.

Input device 240, display 250 and printer 260 are also in communication with communication bus 220. Any known input device may be used as input device 240, including a keyboard, mouse, touch pad, voice-recognition system, or any combination of these devices. Input device 240 may be used by an entity operating server 200 to input sensor measurements, operational commands, and other information to server 200. Of course, such information may also be input to server 200 via communication port 230.

Display 250 may output text and graphics to an operator of server 200 in response to commands issued by microprocessor 210, and may be an integral or separate CRT display, flat-panel display or the like. Printer 260 may also output text and graphics, but in hardcopy form using ink-jet, thermal, dot-matrix, laser, or other printing technologies.

RAM 270 is connected to communication bus 220 to provide microprocessor 210 with fast data storage and retrieval. In this regard, processor-executable process steps being executed by microprocessor 210 are typically stored temporarily in RAM 270 and executed therefrom by microprocessor 210. ROM 280, in contrast, provides storage from which data can be retrieved but to which data cannot be stored. Accordingly, ROM 280 is used to store invariant process steps and other data, such as basic input/output instructions and data used during system boot-up or to control communication port 230. It should be noted that one or both of RAM 270 and ROM 280 may communicate directly with microprocessor 210 instead of over communication bus 220.

Data storage device 290 stores server program 292, Web server 294, and sensor measurement database 296. Server program 292 consists of processor-executable process steps executed by microprocessor 210 in order to control server 200 to obtain information associated with a location in accordance with the present invention. More specifically, the process steps of server program 292 may be executed by microprocessor 210 to search a network for sensor measurements associated with a location and to acquire from the network a plurality of sensor measurements associated with the location, wherein the identified plurality of sensor measurements are measurements obtained by a plurality of entities. As described above, these features enable a user to efficiently leverage the current and future network of publicly-accessible sensors to acquire disparate sensor measurements associated with a given location.

The process steps of server program 292 may be read from a computer-readable medium, such as a floppy disk, a CD-ROM, a DVD-ROM, a Zip™ disk, a magnetic tape, or a signal encoding the process steps, and then stored in data storage device 290 in a compressed, uncompiled and/or encrypted format. In alternative embodiments, hard-wired circuitry may be used in place of, or in combination with, processor-executable process steps for implementation of the processes of the present invention. Thus, embodiments of the present invention are not limited to any specific combination of hardware and software.

Web server 294 also comprises processor-executable process steps. The process steps may be executed by microprocessor 210 to transmit and receive data over the Web. More particularly, the process steps of Web server 294 may be executed to receive requests for information from Web clients, such as Web browsers, and to transmit data in response to received requests.

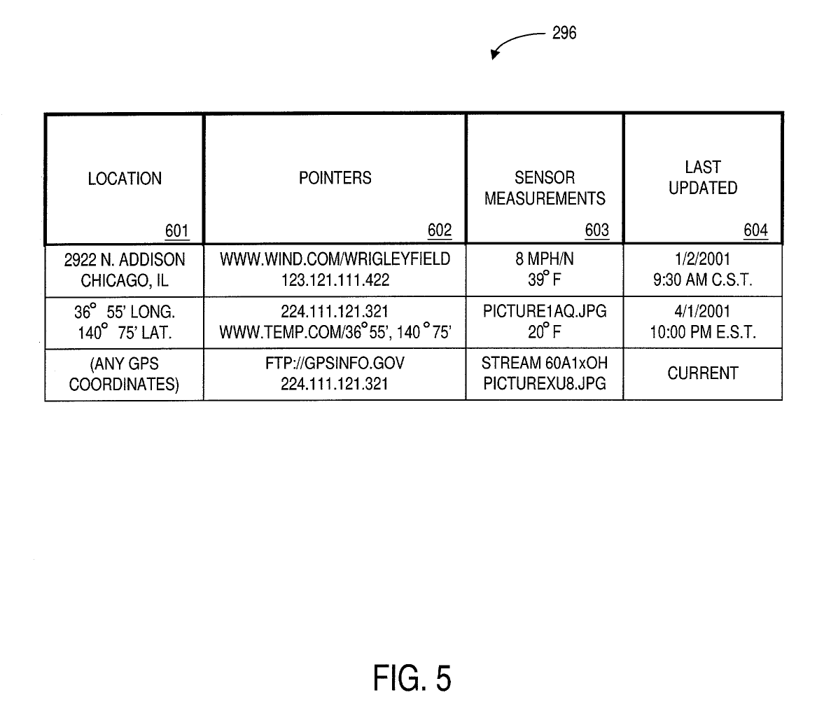

Sensor measurement database 296 includes sensor measurements associated with a plurality of locations. In operation, sensor measurement database 296 may be used to store a plurality of sensor measurements acquired from a network after a search for sensor measurements associated with a location. A specific example of a portion of sensor measurement database 296 will be described with respect to FIG. 5.

In some embodiments, data storage device 290 also stores other unshown elements that may be necessary for operation of server 200, such as other applications, other data files, an operating system, a database management system and “device drivers” for allowing microprocessor 210 to interface with devices in communication with communication port 230. These elements are known to those skilled in the art, and are therefore not described in detail herein.

User Device

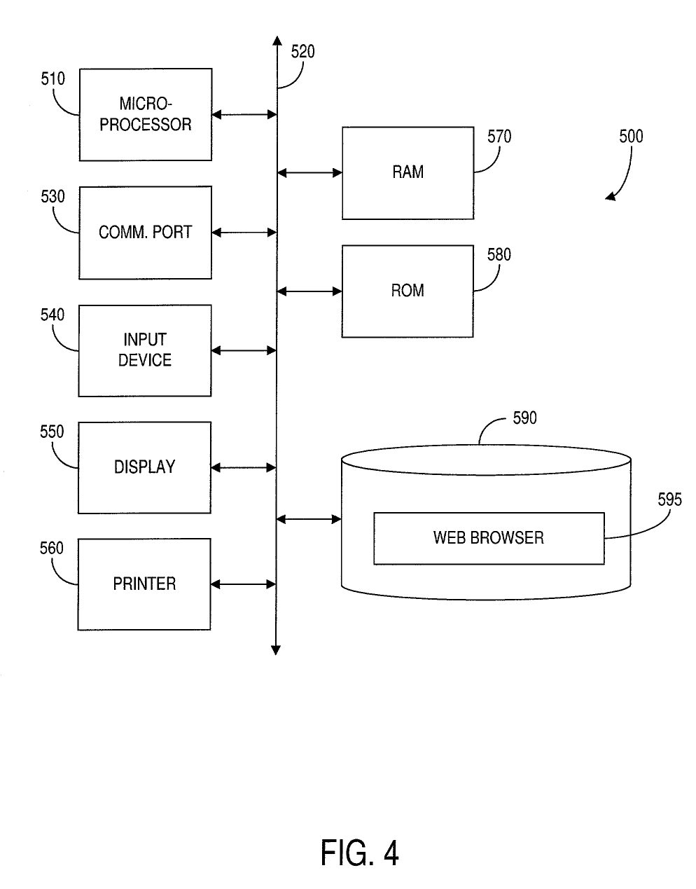

FIG. 4 illustrates several components of user device 500 according to one embodiment of the invention. The components may comprise any of the specific examples set forth above with respect to identically-named components of server 200. Of course, specific functions performed by the components may differ from the functions performed by the identically-named components.

For example, microprocessor 510 may be used to execute processor-executable process steps to transmit a request to obtain information associated with a location, to receive the information and to present the information to a user. In this regard, communication port 530 may be used to transmit the request and receive the information, a user may operate input device 540 to input the request, and the information may be presented using display 550 and/or printer 560. Of course, each of these components may be used to provide other functionality to the user in accordance with other applications executed by user device 500.

Data storage device 590 stores processor-executable process steps of Web browser 595. The process steps of Web browser 595 may be executed by microprocessor 510 to allow user device 500 to send and receive information over the Web. More specifically, Web browser 595 allows user device 500 to transmit requests for information to and to receive information from a device executing process steps of a Web server, such as server 200. As described with respect to data storage device 290, data storage device 590 may also store other known elements that may be necessary for operation of user device 500.

Sensor Measurement Database

A tabular representation of a portion of sensor measurement database 296 is shown in FIG. 5. The information stored in sensor measurement database 296 may be entered by an employee through input device 240 of server 200, or may be received from a remote device over communication port 230. As described above, the information stored in sensor measurement database 296 may be used to store a plurality of sensor measurements acquired from a network after a search for sensor measurements associated with a location.

Sensor measurement database 296 includes several records and associated fields. The fields include location field 601, pointer field 602, sensor measurements field 603, and last updated field 604. Of course, sensor measurement database 296 may include many more records and each record may include fields other than those shown in FIG. 5.

Location field 601 represents a location associated with a particular record. A location may be represented in location field 601 using a postal address, latitude and longitude coordinates, Global Positioning System (GPS) coordinates, or any other convention for specifying a location. Pointers field 602 specifies pointers that may be used to acquire sensor measurements associated with a location represented in an associated location field 601. More than one pointer may be specified in pointers field 602, and a pointer may populate more than one pointers field 602 in order to associate the pointer with more than one location.

Pointers may comprise an IP address, a Web address, a File Transfer Protocol address, or any other pointer using which information may be acquired from a network. Location and pointer information used to populate associated ones of location field 601 and pointers field 602 may be obtained from a WebCrawler or other device for searching a network for information, from a operator through input device 240, or from another device charged with transmitting such information to server 200.

Sensor measurements field 603 specifies sensor measurements obtained using the pointers of associated pointers field 602. Accordingly, the sensor measurements of a record are associated with a location specified in location field 601 of the record. Sensor measurements stored in sensor measurements field 603 may comprise wind data, temperature data, image data, video data, or the like.

Last updated field 604 indicates a time at which sensor measurements in an associated sensor measurements field 603 were last updated. In this regard, data in sensor measurements field 603 may be periodically updated or updated when data for an associated location is updated. Last updated field 604 indicates “Current” in a case that an associated sensor measurements field 603 reflects real-time data. Last updated field 604 may specify a time and date or a count-up timer. In one embodiment described in detail below, last updated field 604 is used to determine whether associated sensor measurements satisfy a timeframe. If so, the sensor measurements are acquired. If not, pointers from associated pointers field 602 are used to acquire more-current sensor measurements.

As will be understood by those skilled in the art, the illustration and accompanying description of sensor measurement database 296 merely represent relationships between stored information. A number of other arrangements may be employed besides those suggested. Similarly, the illustrated fields and field values represent sample information only; those skilled in the art will understand that the amount and content of this information may be different from that illustrated.

Specific Example

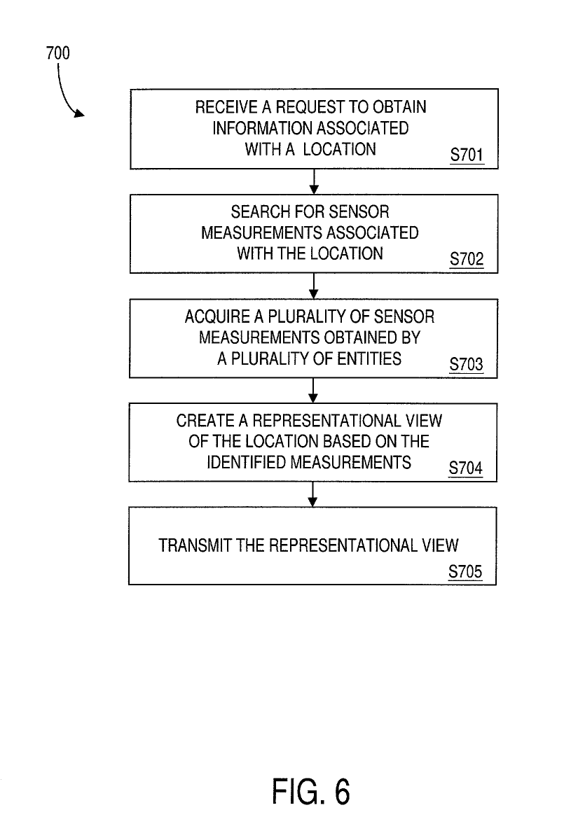

FIG. 6 sets forth process steps 700 to acquire sensor measurements associated with a location according to some embodiments of the present invention. Process steps 700 are described herein as being included in server program 292 and executed by server 200, however, it should be noted that various ones of the process steps may be included in Web browser 294 or other programs and executed by any device or number of devices, and that some of process steps 700 may be performed manually.

Briefly, according to process steps 700, a network is searched for sensor measurements associated with a location, and a plurality of sensor measurements associated with the location is acquired from the network, with the acquired plurality of sensor measurements including measurements obtained by a plurality of entities. By virtue of these features, a user may be able to efficiently receive a representation of the location based on available sensor measurements.

Initially, a request to obtain information associated with a location is received in step S701. According to a specific example, a user inputs a location into a user interface displayed on display 550 by process steps of Web browser 595, and a request to obtain information such as sensor measurements associated with the location is received over communication port 230 of server 200. Process steps of Web server 294 are executed to receive the request and the request is passed to server program 292.

In step S702, a search is conducted for sensor measurements associated with the location. For example, sensor measurement database 296 may be searched in step S702 for a record including a location field 601 specifying the location. The records may be populated prior to step S702 by periodically searching a network for sensor measurements associated with a plurality of locations, and by acquiring a plurality of the sensor measurements for storage in database 296.

Server 200 may also or alternatively search a network to which it is directly or indirectly connected, such as the Web, for sensor measurements associated with the location in step S702. The search may be conducted using WebCrawler technologies, using pointers associated with the location in sensor measurement database 296, or using any other system. In some embodiments, a database of mobile sensors (such as car-mounted sensors) is searched in step S702 to determine whether any of the mobile sensors are present in an area corresponding to the received location. According to one such embodiment, the database includes information, such as IP addresses, which can be used to determine a location of each mobile sensor.

A plurality of sensor measurements is acquired in step S703, with the plurality of measurements having been obtained by a plurality of entities. The acquired sensor measurements may be those identified during the search of step S702. The sensor measurements may be acquired by reading data stored in a field of sensor measurement database 296 or by using a pointer to acquire a sensor measurement directly from an associated sensor. Returning to the mobile sensor embodiment, sensor measurements are acquired from those mobile sensors determined to be located within a threshold proximity of the received location.

In some embodiments of step S703, it is determined that an identified sensor measurement does not satisfy a timeframe requirement based on the location and/or the nature of the sensor measurement. That is, it may be determined that a time at which a stored sensor measurement associated with the location was last updated is too distant to be reliable or useful. According to an example, a sensor measurement associated with the location and stored in sensor measurement database 296 may represent traffic congestion. However, if the stored sensor measurement was last updated 12 hours ago, it is determined that the measurement does not meet a timeframe requirement, which in this example is equal to ten minutes. Therefore, a pointer associated with the sensor measurement is used in step S703 to access an updated sensor measurement directly from an associated sensor. If the sensor measurement satisfies the timeframe requirement, the sensor measurement is simply acquired from database 296.

After the plurality of sensor measurements is acquired, a representational view of the location is created in step S704 based on the acquired sensor measurements. The representational view may be any view of the location presenting one or more of the acquired sensor measurements, including a topographical map, an infra-red display, a picture having weather data superimposed thereon, thumbnail versions of available images, a composite of several images “stitched” together, or the like. The representational view may also include audio tracks. In some embodiments, the representational view is placed in a Web page format such as HTML or XML by process steps of Web server 294. In this regard, the representational view is transmitted in step S705.

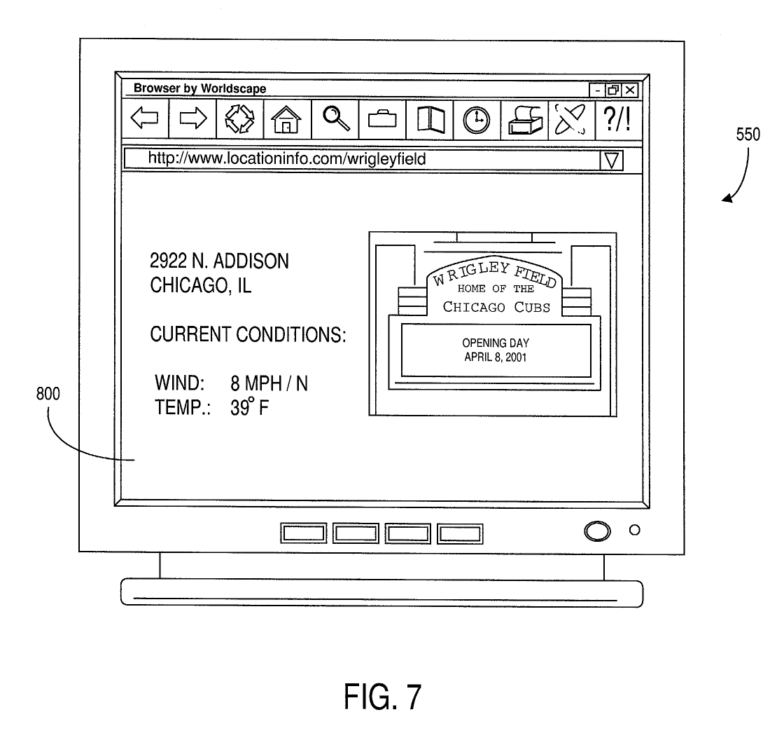

FIG. 7 is a view of display 550 after execution of step S705. As shown, HTML page 800 is displayed in a window provided by process steps of Web browser 595. In accordance with the present invention, page 800 is a representational view of an associated location and includes image data, wind data and temperature data obtained by a plurality of entities.

According to one arrangement, the representational view is transmitted to the user device from which the request was received in step S701. In this example, the view may be customized according to preferences of a user operating the user device. Customization may consist of determining the user preferences and providing a particular type of representational view based on the preferences. The preferences may specify a preferred perspective, mix of audio tracks, etc, and may be determined by querying the user or using learning algorithms or behavioral inference.

In some embodiments, the representational is interactive, allowing the user to select certain aspects of the view for enhancement or for a perspective change. Also, server 200 may extract payment from the user in exchange for the representational view, perhaps basing the view's degree of detail or interactivity on the amount of payment.

Process steps 700 may be altered to create embodiments of the invention according to any of the alternative arrangements mentioned herein. Moreover, although the present invention has been described with respect to particular embodiments and alternative arrangements thereof, those skilled in the art will note that various substitutions may be made to those embodiments and arrangements without departing from the spirit and scope of the present invention.

What is claimed is:

1. A method for acquiring information associated with a location, comprising:
searching a network for sensor measurements associated with a location; and
acquiring from the network a plurality of sensor measurements associated with the location,
wherein the identified plurality of sensor measurements are measurements obtained by a plurality of entities.

2. A method according to claim 1, further comprising:
storing the plurality of sensor measurements in association with the location.

3. A method according to claim 1, further comprising:
receiving a request to obtain information associated with the location.

4. A method according to claim 3, wherein the acquiring step comprises:
identifying a stored sensor measurement associated with the location;
determining if the stored sensor measurement satisfies a timeframe requirement; and
if the stored sensor measurement does not satisfy the timeframe requirement, acquiring a sensor measurement satisfying the timeframe requirement.

5. A method according to claim 4, wherein the step of acquiring a sensor measurement satisfying the timeframe requirement comprises:
identifying a pointer associated with the location; and
acquiring a sensor measurement satisfying the timeframe requirement based on the pointer.

6. A method according to claim 5, wherein the pointer is associated with the stored sensor measurement.

7. A method according to claim 1, further comprising:
creating a representational view of the location based on the acquired plurality of sensor measurements.

8. A method according to claim 7, further comprising:
receiving information representing the location from a user; and
presenting the representational view to the user.

9. A method according to claim 8, wherein the representational view is presented in accordance with preferences associated with the user.

10. A method according to claim 1, wherein the step of acquiring comprises:
analyzing a stored data structure comprising a plurality of locations and, associated with each location, pointers for acquiring one or more sensor measurements.

11. A method according to claim 10, further comprising:
using pointers associated with the location to acquire the plurality of sensor measurements.

12. A method according to claim 1, wherein the step of acquiring comprises:
analyzing a stored data structure comprising a plurality of locations and one or more sensor measurements associated with each location.

13. A method according to claim 1, wherein one or more of the identified plurality of sensor measurements are obtained by mobile sensors that are at some times not associated with the location.

14. A medium storing processor-executable process steps to acquire information associated with a location, the process steps comprising:
a step to search a network for sensor measurements associated with a location; and
a step to acquire from the network a plurality of sensor measurements associated with the location,
wherein the identified plurality of sensor measurements are measurements obtained by a plurality of entities.

15. A medium according to claim 14, the process steps further comprising:
a step to store the plurality of sensor measurements in association with the location.

16. A medium according to claim 14, the process steps further comprising:
a step to receive a request to obtain information associated with the location.

17. A medium according to claim 16, wherein the acquiring step comprises:
a step to identify a stored sensor measurement associated with the location;
a step to determine if the stored sensor measurement satisfies a timeframe requirement; and
if the stored sensor measurement does not satisfy the timeframe requirement, a step to acquire a sensor measurement satisfying the timeframe requirement.

18. A medium according to claim 17, wherein the step to acquire a sensor measurement satisfying the timeframe requirement comprises:
a step to identify a pointer associated with the location; and
a step to acquire a sensor measurement satisfying the timeframe requirement based on the pointer.

19. A medium according to claim 18, wherein the pointer is associated with the stored sensor measurement.

20. A medium according to claim 14, the process steps further comprising:
a step to create a representational view of the location based on the acquired plurality of sensor measurements.

21. A medium according to claim 20, the process steps further comprising:
a step to receive information representing the location from a user; and
a step to present the representational view to the user.

22. A medium according to claim 21, wherein the representational view is presented in accordance with preferences associated with the user.

23. A medium according to claim 14, wherein the step to acquire comprises:
a step to analyze a stored data structure comprising a plurality of locations and, associated with each location, pointers for acquiring one or more sensor measurements.

24. A medium according to claim 23, the process steps further comprising:
a step to use pointers associated with the location to acquire the plurality of sensor measurements.

25. A medium according to claim 14, wherein the step to acquire comprises:
a step to analyze a stored data structure comprising a plurality of locations and one or more sensor measurements associated with each location.

26. A medium according to claim 14, wherein one or more of the identified plurality of sensor measurements are obtained by mobile sensors that are at some times not associated with the location.

27. An apparatus to acquire information associated with a location, comprising:
a processor; and
a storage device in communication with said processor and storing instructions adapted to be executed by said processor to:
search a network for sensor measurements associated with a location; and
acquire from the network a plurality of sensor measurements associated with the location,
wherein the identified plurality of sensor measurements are measurements obtained by a plurality of entities.

28. An apparatus according to claim 27, wherein the stored instructions comprise instructions adapted to be executed by said processor to:
store the plurality of sensor measurements in association with the location.

29. An apparatus according to claim 27, wherein the stored instructions comprise instructions adapted to be executed by said processor to:
receive a request to obtain information associated with the location.

30. An apparatus according to claim 29, wherein the stored instructions adapted to be executed by said processor to acquire the plurality of sensor measurements comprise stored instructions adapted to be executed by said processor to:
identify a stored sensor measurement associated with the location;
determine if the stored sensor measurement satisfies a timeframe requirement; and
if the stored sensor measurement does not satisfy the timeframe requirement, acquire a sensor measurement satisfying the timeframe requirement.

31. An apparatus according to claim 30, wherein the stored instructions adapted to be executed by said processor to acquire the sensor measurement comprise stored instructions adapted to be executed by said processor to:
identify a pointer associated with the location; and
acquire a sensor measurement satisfying the timeframe requirement based on the pointer.

32. An apparatus according to claim 31, wherein the pointer is associated with the stored sensor measurement.

33. An apparatus according to claim 27, wherein the stored instructions comprise stored instructions adapted to be executed by said processor to:
create a representational view of the location based on the acquired plurality of sensor measurements.

34. An apparatus according to claim 33, wherein the stored instructions comprise stored instructions adapted to be executed by said processor to:
receive information representing the location from a user; and
to present the representational view to the user.

35. An apparatus according to claim 34, wherein the representational view is presented in accordance with preferences associated with the user.

36. An apparatus according to claim 27, wherein the stored instructions adapted to be executed by said processor to acquire the plurality of sensor measurements comprise stored instructions adapted to be executed by said processor to:
analyze a stored data structure comprising a plurality of locations and, associated with each location, pointers for acquiring one or more sensor measurements.

37. An apparatus according to claim 36, wherein the stored instructions comprise stored instructions adapted to be executed by said processor to:
use pointers associated with the location to acquire the plurality of sensor measurements.

38. An apparatus according to claim 27, wherein the stored instructions adapted to be executed by said processor to acquire the plurality of sensor measurements comprise stored instructions adapted to be executed by said processor to:
analyze a stored data structure comprising a plurality of locations and one or more sensor measurements associated with each location.

39. An apparatus according to claim 27, wherein one or more of the identified plurality of sensor measurements are obtained by mobile sensors that are at some times not associated with the location.

40. A system to acquire location information, comprising:
a user device for receiving a location from a user, for transmitting a request to receive information associated with the location, for receiving a representational view of the location, and for presenting the representational view to the user; and
a server for receiving the request, for searching a network for sensor measurements associated with the location, for acquiring from the network a plurality of sensor measurements associated with the location, for creating the representational view, and for transmitting the representational view to the user device,
wherein the identified plurality of sensor measurements are measurements obtained by a plurality of entities.

41. A system according to claim 40, wherein the server determines whether mobile sensors are located within a threshold proximity of the location and, if so, acquires sensor measurements from the mobile sensors.
